(19) United States
(12) Patent Application Publication
(10) Pub. No.: US 2010/0056060 A1
(43) Pub. Date: Mar. 4, 2010

(54) WIRELESS POCKET TRANSMITTER

(75) Inventor: Frank Hagemeyer, Wedemark (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser electronic GmbH & Co. KG, Wedemark (DE)

(21) Appl. No.: 12/547,930

(22) Filed: Aug. 26, 2009

(30) Foreign Application Priority Data
Aug. 28, 2008 (DE) 10 2008 044 727.7

(51) Int. Cl. H04B 1/00

(52) U.S. Cl. 455/63.1

(57) ABSTRACT

There is provided a wireless pocket transmitter comprising an input for receiving signals of a guitar, a capacitance adjusting unit for adjusting an input capacitance of the pocket transmitter, and a wireless transmitter.

The present invention concerns a wireless pocket transmitter.

Guitars are typically electrically connected by way of guitar cables to a downstream-disposed amplifier and/or signal processing unit. In the meantime however guitars have also been wirelessly connected to the downstream-disposed amplifier and signal processing unit.

Therefore an object of the present invention is to provide a wireless pocket transmitter which is capable of exactly reproducing the sound of a cable-connected guitar.

That object is attained by a wireless pocket transmitter as set forth in claim 1.

Thus there is provided a wireless pocket transmitter comprising an input for receiving signals of a guitar, a capacitance adjusting unit for adjusting an input capacitance of the pocket transmitter, and a transmitter for wirelessly transmitting the signals received by way of the input.

In accordance with an aspect of the present invention the pocket transmitter has at least one operating element for selecting the input capacitance. The input capacitance can be selected by means of the capacitance adjusting unit in dependence on the values adjusted by the operating element.

The invention concerns the notion of providing a pocket transmitter having an input capacitance which is adjustable or which can be switched over. In that case the (receiving) load capacitance of the pocket transmitter can be matched to the capacitance of a guitar cable (which is usually employed).

The invention is based on the realisation that an influence of guitar cables of different lengths on the sound of an electric guitar is also to be reproduced in the case of a wireless electric guitar. It should be pointed out that a wound sound pick-up of an electric guitar typically has an inductance of about 2H. If a guitar cable is connected to the sound pick-up, that can involve a loading on the sound pick-up. The capacitance of a guitar cable can be between 200 pF and 1 nF. The consequence of that is that there is a second-order low pass comprising the sound pick-up inductance and the load capacitance of the guitar cable, the second-order low pass representing a low pass with an excessive resonance rise. It is to be pointed out that the exact value of the cable capacitance has an influence on the resonance frequency of the second-order low pass. A resonance can typically be between 2 and 5 kHz. That however represents the range with the greatest auditory sensitivity and is crucially responsible for the metallic sound of an electric guitar.

Further configurations of the invention are subject-matter of the appendant claims.

Embodiments by way of example and advantages of the invention are described in greater detail hereinafter with reference to the drawing.

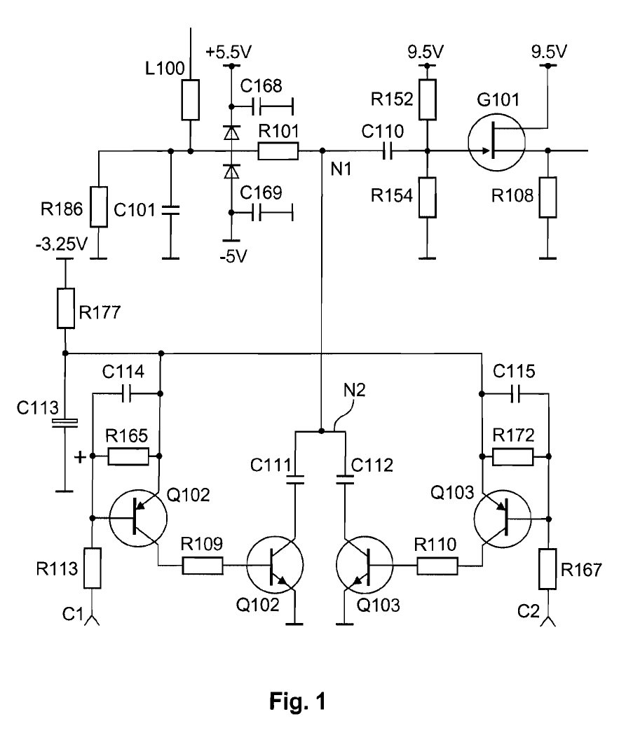

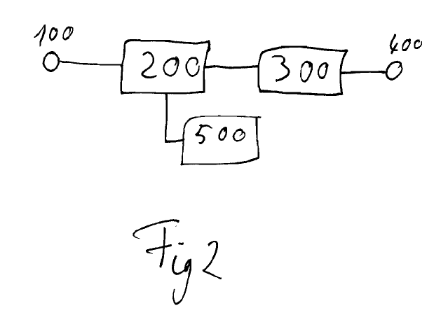

FIG. 1 shows a diagrammatic circuit layout of a capacitance adjusting unit in a wireless pocket transmitter according to the invention, and FIG. 2 shows a block circuit diagram of a wireless pocket transmitter according to the invention.

FIG. 1 shows a diagrammatic circuit layout of a capacitance adjusting unit 200 in a wireless pocket transmitter according to the invention. The circuit in FIG. 1 receives an input signal by way of a coil L100. The coil L100 is coupled to a resistor R101 which in turn is coupled by way of a node N1 to a capacitor C110. A pre-amplifier Q101 is in turn coupled to the capacitor 110. Thus an input signal can pass to the amplifier Q101 by way of the coil L100, the resistor R101 and the capacitor C110. The first node N1 is connected to a second node N2, at which two capacitors C111, C112 are coupled. Those capacitors C111, C112 are in turn coupled to two transistors Q102, Q103, those capacitors C111, C112 are used as input capacitors which can be switched on. Those input capacitors C111, C112 can be switched on by way of the switching transistors Q102, Q103. The two transistors can be actuated for example by a microcontroller by way of the lines C1 and C2. The circuit shown in FIG. 1 represents an inexpensive circuit.

Stepped switching-over of the input capacitance can be effected with the FIG. 1 circuit.

FIG. 2 shows a block circuit diagram of a wireless pocket transmitter according to the invention. The wireless pocket transmitter has an input 100, a capacitance adjusting unit 200 and a wireless transmitter 300. In this case the capacitance adjusting unit 200 corresponds to the capacitance adjusting unit shown in FIG. 1. Signals for example of an electric guitar can be received by way of the input 100 and the input capacitance can be adjusted by means of the capacitance adjusting unit. Those signals can then be wirelessly transmitted by means of the wireless transmitter 300. The wireless transmitter can further have an operating element 500 which is adapted to set or select a desired input capacitance by means of the capacitance adjusting unit 200.

It should be noted that the power consumption is relatively low at least in comparison with the overall power consumption of the transmitter. The base currents are only about 200 microamps. If capacitances which are switched in noise-free fashion are used, that circuit will not worsen the equivalent inherent noise of the transmitter. This circuit makes it possible to simulate a plurality of guitar cable lengths so that the corresponding sound can be directly reproduced.

In accordance with a further embodiment of the present invention there is provided a capacitance switching-over unit which can be provided in a separate housing between an electric guitar and a pocket transmitter. The capacitance switching-over unit can have input capacitances which can be switched over or steplessly altered. In addition thereto it can have a buffer amplifier with a battery supply.

The selection of the switchable input capacitance as shown in FIG. 1 and in accordance with the further embodiment can be effected for example by means of operating elements on or in a pocket transmitter. Thus a customer can select for example by means of a menu, which input capacitance is to be switched on. A preferred sound impression can be provided in accordance with the selected input capacitance.

As an alternative to the above-described switching-over stage having two capacitors it is also possible to implement a switching-over stage having three capacitors so that eight-stage switching over of the input capacitance is possible.

As an alternative to a switching-over unit or stepped switching-over of the input capacitance, the capacitance adjusting unit can also permit stepless adjustment of the capacitance. That can be effected for example by tunable diodes. That can permit stepless adjustment of the input capacitance. Alternatively or additionally thereto a rotary variable capacitor can be provided.

1. A wireless pocket transmitter comprising
an input for receiving signals of a guitar,
a capacitance adjusting unit for adjusting an input capacitance of the pocket transmitter, and
a transmitter for wirelessly transmitting the signals received by way of an input.

2. A pocket transmitter as set forth in claim 1 and further comprising
at least one operating element for selecting the desired input capacitance,
wherein an input capacitance is adjusted in dependence on the values selected by the operating element.

3. A pocket transmitter as set forth in claim 1 wherein the capacitance adjusting unit has a capacitance switching-over unit with at least two capacitors.

4. A pocket transmitter as set forth in claim 1 wherein the capacitance adjusting unit has a steplessly adjustable capacitance.
